(19) United States
(12) Patent Application Publication
(10) Pub. No.: US 2015/0004456 A1
(43) Pub. Date: Jan. 1, 2015

(54) SODIUM METAL HALIDE CURRENT COLLECTOR

(71) Applicant: GENERAL ELECTRIC COMPANY, SCHENECTADY, NY (US)

(72) Inventors: ROBERT CHRISTIE GALLOWAY, Quarndon Derby (GB); ROGER NEIL BULL, Derby (GB); JAMES LOWE SUDWORTH, Burton-On-Trent (GB); PAUL SUDWORTH, Ashby de la Zouch (GB); CONNOR BRADY, Birmingham (GB); MICHAEL BARONE, Ballston Spa, NY (US)

(21) Appl. No.: 13/942,729

(22) Filed: Jul. 16, 2013

Related U.S. Application Data
(60) Provisional application No. 61/839,487, filed on Jun. 26, 2013.

(51) Int. Cl. H01M 4/75; H01M 10/38; H01M 10/39; H01M 4/58

(52) U.S. Cl. CPC H01M 4/75; H01M 4/582; H01M 10/38; H01M 10/39; H01M 2220/10; H01M 2220/20
USPC 429/105; 429/209; 29/623.1

(57) ABSTRACT

Fin-based current collectors provide high performance and cost savings in electrochemical cells. Embodiments of the invention provide a current collector for a sodium-metal halide electrochemical cell having at least one substantially flat and elongated metal fin being electrically conductive and having at least one bend with respect to a dominant longitudinal axis of the current collector. The at least one substantially flat and elongated metal fin is configured to be joined to a metal ring of the electrochemical cell via one of welding or brazing.

### BACKGROUND

1. Technical Field

The subject matter disclosed herein relates to current collectors for at least sodium metal halide electrochemical cells.

2. Discussion of Art

Advanced batteries based on sodium-metal halide chemistry have been explored for use in electric vehicle applications and in critical stationary applications because of their high specific energy, power density, and long cyclic life. An electrochemical cell of a sodium-metal halide battery includes a current collector within a cathode region of the cell. The current collector provides a low resistance pathway for electrons to enter and exit the cathode region of a sodium-metal halide cell. The design of the current collector can have a significant effect on cell performance and the current collector can be one of the more expensive components of an electrochemical cell.

### BRIEF DESCRIPTION

Low cost, high performance current collectors for at least sodium metal halide electrochemical cells are disclosed. Total battery cost may be reduced by either reducing the cost of the components or by improving the performance of the cell. Embodiments herein relate to reducing the cost of the current collector by providing one or more flat metal fins as part of a current collector.

In one embodiment, a current collector for a sodium-metal halide electrochemical cell is provided. The current collector includes at least one substantially flat and elongated metal fin being electrically conductive and having at least one bend with respect to a dominant longitudinal axis of the current collector, wherein the at least one substantially flat and elongated metal fin is configured to be joined to a metal ring of the electrochemical cell via one of welding or brazing. The current collector may further include a proximal end configured to be joined to the metal ring of the electrochemical cell, and a distal end. The bend may be near the proximal end and may be less than or equal to 45° with respect to the dominant longitudinal axis of the current collector, or may be less than or equal to 90° with respect to the dominant longitudinal axis of the current collector. The metal ring may include one of an outer metal ring or an inner metal ring of the electrochemical cell. The metal ring may have an outer circumference and an inner circumference. The proximal end of the current collector may be configured to be joined to a portion of the inner circumference. The substantially flat and elongated metal fin may be curved in a width dimension providing rigidity. The substantially flat and elongated metal fin may be tapered along a length dimension, being widest at the proximal end of the current collector. The current collector may be configured to be substantially centered within the electrochemical cell when joined to the metal ring.

The at least one substantially flat and elongated metal fin may include at least two interleaved metal fins, each fin having a distal end and a split proximal end. The split proximal end of each fin provides two connection surfaces to the metal ring in the form of two bends of the at least one bend. In accordance with an embodiment, the at least two interleaved metal fins are not in direct contact with each other. The current collector may include a wicking material running along a central axis of the at least two interleaved metal fins in a length dimension, wherein each of the at least two interleaved metal fins are slotted along the central axis to accommodate the wicking material.

In accordance with an embodiment, the at least one substantially flat and elongated metal fin is folded in half to form a fork at a proximal end of the current collector and to form the at least one bend at a distal end of the current collector, wherein the at least one bend is about 180° with respect to the dominant longitudinal axis of the current collector. The fork may include two bent prongs configured to be connected to the metal ring of the electrochemical cell, wherein the metal ring is an outer ring of the electrochemical cell, and wherein each of the two bent prongs includes a rounded outer tip configured to match a curvature of an inner wall of the outer ring, and wherein the two bent prongs provide a spring tension to hold each of the rounded outer tips against the inner wall. The current collector may include a wicking material running along the dominant longitudinal axis of the current collector.

In one embodiment, an electrochemical cell is provided. The electrochemical cell includes a cathode chamber containing an active material and at least one metal ring positioned above the cathode chamber. The electrochemical cell also includes a current collector residing within the cathode chamber. The current collector includes at least one substantially flat and elongated metal fin being electrically conductive and having at least one bend with respect to a dominant longitudinal axis of the current collector. The fin may be joined to the metal ring via one of welding or brazing. The active material may include a mix of at least nickel, salt, and a liquid electrolyte. The current collector and the metal ring may be made of nickel or nickel-plated copper.

In one embodiment, a method of assembling an electrochemical cell is provided. The method includes interleaving at least two substantially flat and elongated metal fins. Each fin has a split proximal end and a distal end and each fin is slotted along a central axis in a length dimension to accommodate the interleaving and a wicking material. The method further includes positioning the wicking material along the slotted central axes of the at least two interleaved metal fins and joining the split proximal end of each metal fin to a metal filling cap. The joining may include one of welding or brazing. The method also includes positioning the interleaved metal fins, having the wicking material, into a cathode cavity of an electrochemical cell and filling the cathode cavity with an active material through the metal filling cap. The method may also include sealing the metal filling cap.

### BRIEF DESCRIPTION OF THE DRAWINGS

Reference is made to the accompanying drawings in which particular embodiments of the invention are illustrated as described in more detail in the description below, in which:

FIG. 1 is a diagram of a cross-section of an exemplary embodiment of an electrochemical cell;

FIG. 2A illustrates a first perspective view of a conventional current collector that may be used in the electrochemical cell of FIG. 1;

FIG. 2B illustrates a second perspective view of a conventional current collector that may be used in the electrochemical cell of FIG. 1;

FIG. 3A illustrates a first perspective view of an example embodiment of a single fin current collector that may be used in the electrochemical cell of FIG. 1 in place of the conventional current collector of FIG. 2A and FIG. 2B;

FIG. 3B illustrates a second perspective view of an example embodiment of a single fin current collector that may be used in the electrochemical cell of FIG. 1 in place of the conventional current collector of FIG. 2A and FIG. 2B;

FIG. 4A illustrates a schematic representation of a side view of the single fin current collector of FIG. 3A and FIG. 3B;

FIG. 4B illustrates a schematic representation of a top view of the single fin current collector of FIG. 3A and FIG. 3B;

FIG. 5A illustrates a perspective exploded view of an example embodiment of an interleaved fin current collector that may be used in the electrochemical cell of FIG. 1 in place of the conventional current collector of FIG. 2A and FIG. 2B;

FIG. 5B illustrates a perspective composite view of the example embodiment of the interleaved fin current collector of FIG. 5A;

FIG. 6A illustrates a schematic representation of two side views of the interleaved fin current collector of FIG. 5B;

FIG. 6B illustrates a schematic representation of a bottom view of the interleaved fin current collector of FIG. 5B;

FIG. 7 illustrates a perspective view of the interleaved fin current collector of FIG. 5B showing a wicking material installed along central axes of the interleaved fins;

FIG. 8A illustrates a schematic representation of a side view of an example embodiment of a folded current collector that may be used in the electrochemical cell of FIG. 1 in place of the conventional current collector of FIG. 2A and FIG. 2B;

FIG. 8B illustrates a blown up side view of a bend at a distal end of the folded current collector of FIG. 8A;

FIG. 8C illustrates a blown up front view of a fork at a proximal end of the folded current collector of FIG. 8A; and

FIG. 8D illustrates a perspective view of the folded current collector of FIG. 8A.

### DETAILED DESCRIPTION

Embodiments of the invention relate to current collectors for electrochemical cells, and reducing the cost of a current collector by providing one or more flat metal fins as part of a current collector. The electrochemical cells may be sodium-metal halide cells used in batteries for stationary or mobile applications, for example.

The term “current collector” as used herein refers to the metal element configured to reside in a cathode chamber of an electrochemical cell filled with active cathode material. A current collector provides a low resistance pathway for electrons to enter and exit the cathode side of an electrochemical cell (e.g., a sodium-metal halide cell). During charging, electrons flow through the current collector and are transferred to the active cathode material through direct contact with the current collector. The higher the current collector surface area, the lower the contact resistance. The term “electrical resistance” as used herein refers to the electrical resistance of the current collector itself. The term “ionic resistance” or “contact resistance” as used herein refers to the electrical resistance between the current collector and the active cathode material. As cell resistances are lowered, power increases and efficiency increases. Increased efficiency results in less heat being generated during charging and discharging cycles and, therefore, less thermal stress on the cells and longer life of the cells. As used herein, the term “dominant longitudinal axis” refers to an imaginary axis running along a longest dimension of the referenced item. As used herein, the term “substantially flat” may mean any of completely flat, completely flat but for manufacturing tolerances, or more flat than not flat (e.g., having a slight curve). As used herein, the term “substantially centered” may mean any of completely centered, more toward the center than not (e.g. shifted slightly off center), or mostly centered (e.g., most of an element is centered but part of the element is not centered).

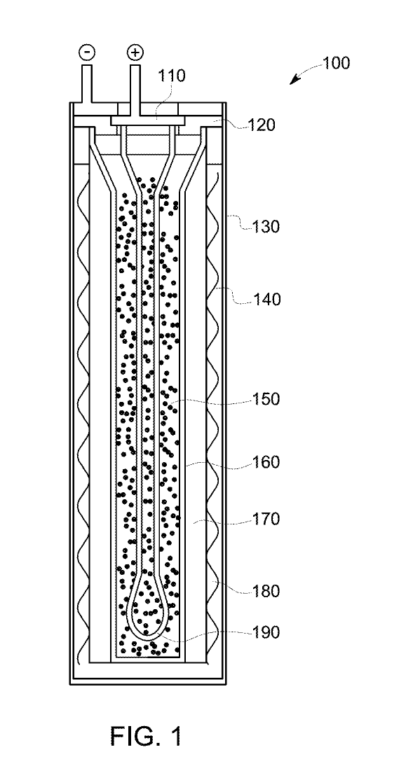

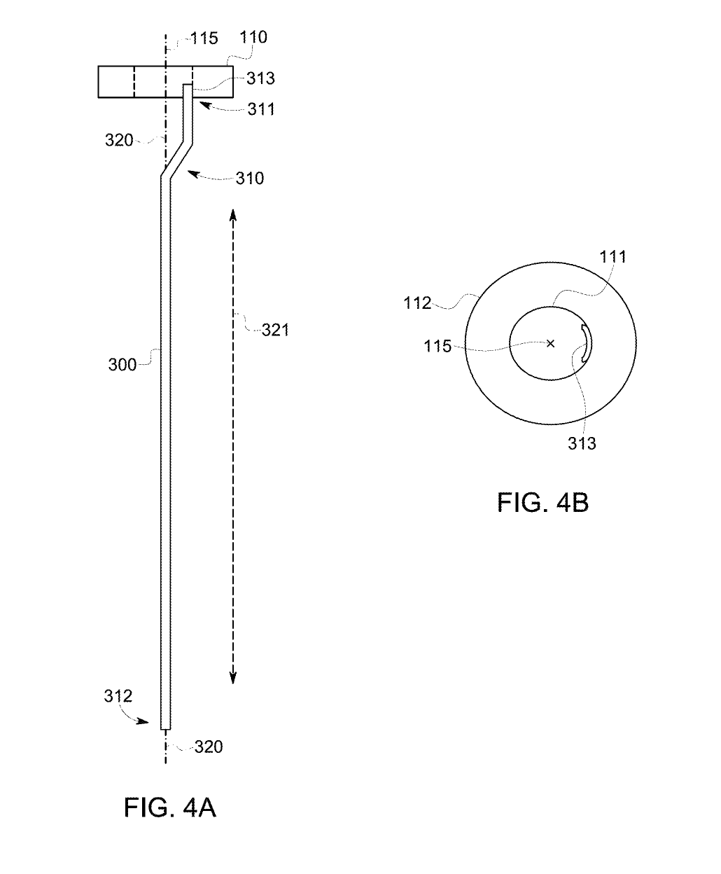

FIG. 1 is a diagram of a cross-section of an exemplary embodiment of an electrochemical cell 100. The cell 100 includes a cap (e.g., a filling cap) in the form of an inner nickel ring 110. The cell 100 also includes an outer nickel ring 120 surrounding the inner nickel ring 110, a cell case 130 (e.g., made of mild steel), a metal shim 140, a cathode chamber 150 (a.k.a., cavity or compartment) containing active cathode material (e.g., a mix of at least nickel, salt, and a liquid electrolyte), an electrode housing 160 surrounding the cathode chamber 150, a ceramic separator 170, (e.g., a beta” alumina solid electrolyte), an anode 180 (e.g., liquid Na), and a nickel current collector 190 residing within the cathode chamber 150 and being joined to the inner nickel ring 110 via welding or brazing. The inner nickel ring 110 has an inner circumference 111 and an outer circumference 112 (see FIG. 4B). In accordance with an embodiment, the inner circumference may provide the boundary of a filling aperture for filling the cathode chamber 150 with the active cathode material. In one embodiment, the diameter of the aperture of the inner nickel rings is about 19 mm. The fill time decreases as the diameter of the aperture is increased, as more material is able to enter the cell through the aperture.

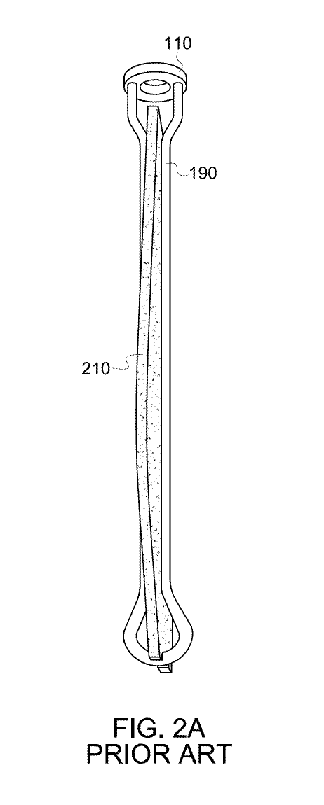

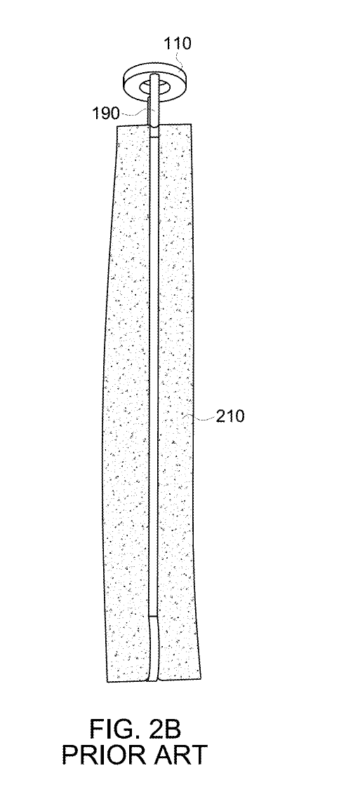

The current collector 190 shown in FIG. 1 may be a conventional current collector similar to that shown in FIG. 2A and FIG. 2B. However, embodiments herein are concerned with replacing the conventional current collector with a lower cost current collector. FIG. 2A illustrates a first perspective view of a conventional current collector 190 that may be used in the electrochemical cell 100 of FIG. 1. FIG. 2B illustrates a second perspective view of the conventional current collector 190 that may be used in the electrochemical cell 100 of FIG. 1. The current collector 190 in FIG. 2A and FIG. 2B is shown as being joined to the nickel inner ring 110 (e.g., the inner nickel ring may serve as a filling cap, allowing the filling of the cathode chamber 150 with active cathode material). Furthermore, the current collector 190 is shown as being a bent solid rod of nickel.

FIG. 2A and FIG. 2B also show a wicking material 210 (e.g., carbon felt) positioned between the two legs of the current collector 190. In operation, the granules of the active cathode material may tend to dry out near the top of the cell, reducing performance of the cell. The wicking material 210 wicks liquid electrolyte upward toward the top of the cell, keeping the granules wet.

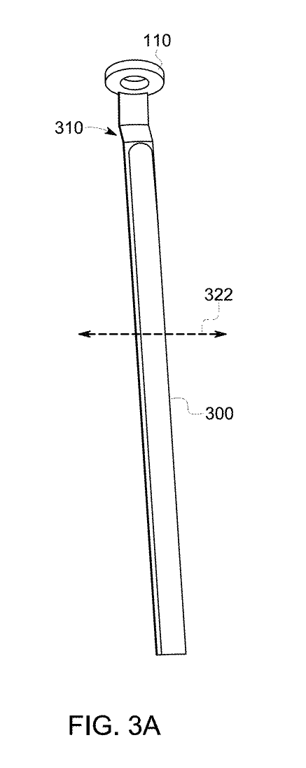

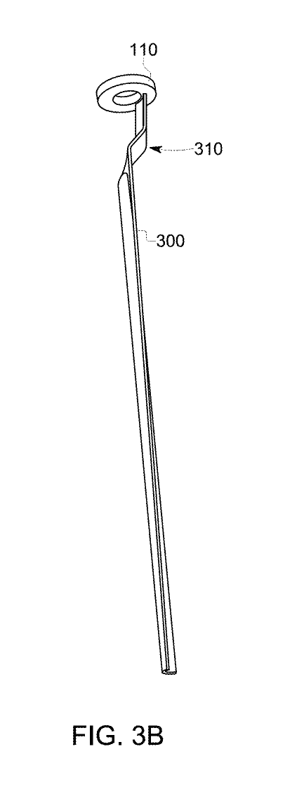

FIG. 3A illustrates a first perspective view of an example embodiment of a single fin current collector 300 that may be used in the electrochemical cell 100 of FIG. 1 in place of the conventional current collector 190 of FIG. 2A and FIG. 2B. FIG. 3B illustrates a second perspective view of the example embodiment of the single fin current collector 300 that may be used in the electrochemical cell 100 of FIG. 1 in place of the conventional current collector 190 of FIG. 2A and FIG. 2B.

The current collector 300 is shown as being joined to an inner nickel ring 110 via, for example, welding or brazing (e.g., ultrasonic welding to provide a low impedance metallurgical bond, or electrical resistance welding). FIG. 4A illustrates a schematic representation of a side view of the single fin current collector 300 of FIG. 3A and FIG. 3B being joined to the inner metal ring 110 at a weld joint 313. FIG. 4B illustrates a schematic representation of a top view of the single fin current collector 300 of FIG. 3A and FIG. 3B showing the inner metal ring 110 and weld joint 313.

In accordance with an embodiment, the single fin current collector 300 is a substantially flat and elongated metal fin being electrically conductive and having a bend 310. The bend 310 may be at an angle of about 30° with respect to a dominant longitudinal axis 320 of the single fin current collector 300 along a length dimension 321, in accordance with an embodiment. However, other angles are possible as well, in accordance with other embodiments. For example, the angle of the bend may be anywhere from 0° to 90°.

In accordance with an embodiment, a ratio of the length of the single metal fin to the width of the single metal fin is about twenty-two, and a ratio of the width of the single metal fin to the thickness of the single metal fin is about ten. Other ratios are possible as well, in accordance with other embodiments. For example, in one embodiment, the fin may have a length to width ratio of from 3:1 to 100:1 or greater. In another embodiment, the fin may have a length to width ratio of from 5:1 to 30:1.

In accordance with one embodiment, the length of the fin may range from 110 mm to 450 mm and the width of the fin may range from 8 mm to 32 mm. In accordance with another embodiment, the length of the fin may range from 200 mm to 250 mm and the width may range from 12 mm to 20 mm. In accordance with various embodiments, a cross-sectional area of the current collector may be between 10 mm² and 40 mm². However, other cross-sectional areas are possible as well, in accordance with other embodiments.

When joined to the inner metal ring 110, the dominant longitudinal axis 320 of the single fin current collector 300 is substantially aligned with a center axis 115 of the inner metal ring 110. The bend 310 facilitates filling of the cathode chamber 150 through the aperture of the filling cap 110 (i.e., the inner metal ring) while allowing the dominant longitudinal axis 320 of the current collector 300 to be substantially centered within the cell 100.

Furthermore, the current collector 300 includes a proximal end 311 and a distal end 312, with the proximal end 311 being configured to be joined to the inner metal ring 110 at an inner circumference 111 of the inner metal ring 110. For example, a curvature of the single fin current collector 300 near the proximal end 311 may match the curvature of the inner circumference 111 of the inner metal ring 110, so as not to have a gap between the components that would make it more difficult to successfully weld the two components. The current collector 300 and the inner metal ring 110 may be made of nickel or nickel-plated copper, for example. However, other types of electrically conductive materials are possible as well, in accordance with other embodiments.

In accordance with an embodiment, the current collector 300 is curved in a width dimension 322, providing rigidity to the elongated metal fin and providing an increased surface area enhancing current collection. Furthermore, the current collector 300 may be tapered along the length dimension 321, being widest at the proximal end 311 and narrowest at the distal end 312. The taper accommodates the fact that the fin carries more collected electrical current toward the proximal end than toward the distal end.

Furthermore, when joined to the inner metal ring 110 and positioned within the cathode chamber 150 of the electrochemical cell 100, the single fin current collector 300 is substantially centered within the electrochemical cell 100, providing uniform current collection within the cathode chamber 150. In accordance with an embodiment, a wicking material is not used with the single fin current collector 300.

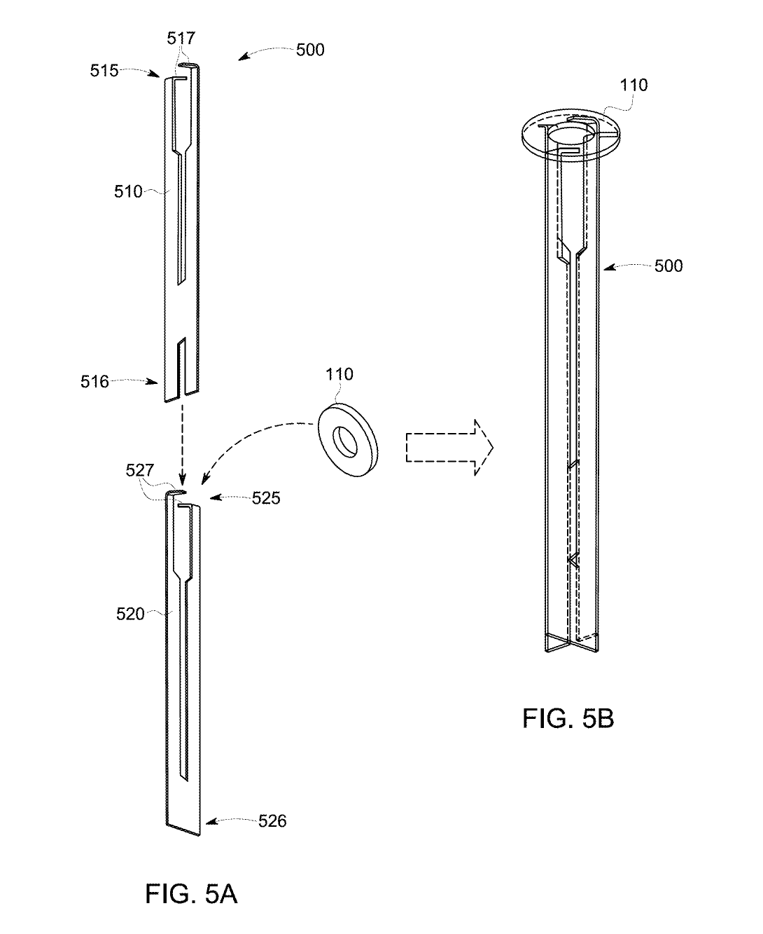

FIG. 5A illustrates a perspective exploded view of an example embodiment of an interleaved metal fin current collector 500 that may be used in the electrochemical cell 100 of FIG. 1 in place of the conventional current collector 190 of FIG. 2A and FIG. 2B. The interleaved metal fin current collector 500 includes a first slotted fin 510 interleaved with a second slotted fin 520. The fins are flat and elongated, providing a broad, low contact electrical resistance surface area. The fins may be stamped or laser cut out of a single piece of nickel material, for example. In accordance with an embodiment, the fins 510 and 520 may each be about 225 mm in length, about 16 mm in width, and about 1 mm in thickness. Other dimensions are possible as well, in accordance with other embodiments. In accordance with one embodiment, the length of a fin may range from 110 mm to 450 mm and the width of a fin may range from 8 mm to 32 mm. In accordance with another embodiment, the length of a fin may range from 200 mm to 250 mm and the width may range from 12 mm to 20 mm. A cross-sectional area of a fin, at a widest point, may be between 10 mm² and 40 mm², in accordance with an embodiment. However, other cross-sectional areas are possible as well, in accordance with other embodiments.

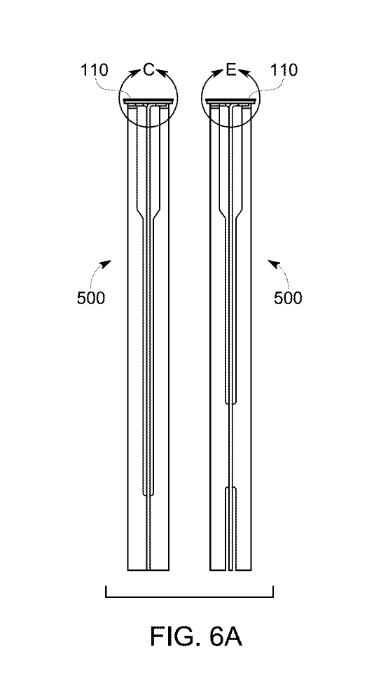

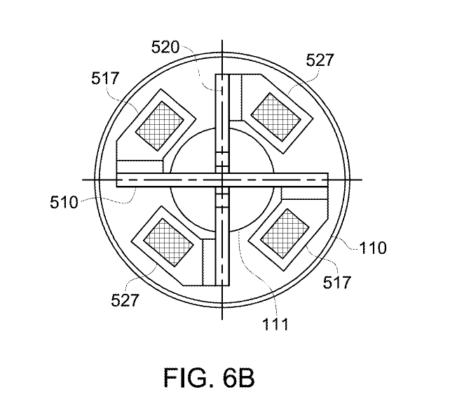

As shown in FIG. 5A, the first slotted fin 510 is configured to be slid down into the second slotted fin 520 along the center lengths of the two fins as facilitated by the slotted nature of the fins, thus forming an interleaved configuration. FIG. 5B illustrates a perspective composite view of the example embodiment of the interleaved metal fin current collector 500 of FIG. 5A joined to an inner metal ring 110. FIG. 6A illustrates a schematic representation of two side views of the interleaved metal fin current collector 500 of FIG. 5B joined to an inner metal ring 110.

In accordance with an embodiment, the fin 510 and the fin 520 each have a split proximal end (515 and 525, respectively) and a distal end (516 and 526, respectively) as shown in FIG. 5A. The split proximal ends 515 and 525 each have two bends being about 90° each (517 and 527, respectively). The 90° bends 517 and 527 provide connection surfaces that may be joined (e.g., via welding or brazing) to an underside of the inner metal ring 110, serving as a filling cap. FIG. 6B illustrates a schematic representation of a bottom view of the interleaved metal fin current collector 500 of FIG. 5B, showing the connection surfaces of the 90° bends 517 and 527 joined to the underside of the inner metal ring 110. The split proximal ends 515 and 525 facilitate the filling of the cathode chamber 150 of the cell 100 through the aperture of the inner metal ring filling cap 110 as bordered by the inner circumference 111.

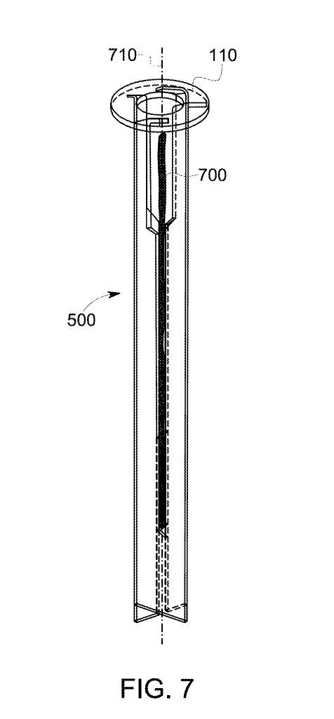

In accordance with an embodiment, the two metal fins 510 and 520 may not be in direct contact with each other when interleaved. For example, the slotted nature of the fins may keep the fins from touching each other when interleaved and joined to the inner metal ring 110. Furthermore, a wicking material 700 (e.g., carbon felt) may be provided running along a central axis 710 of the current collector 500 in a length dimension (see FIG. 7). The slotted nature of the fins 510 and 520 may accommodate the wicking material 700. FIG. 7 illustrates a perspective view of the interleaved fin current collector 500 of FIG. 5B showing a wicking material 700 installed along a central axis 710 of the current collector 500. In accordance with an embodiment, the wicking material 700 is held in place by being compressed between opposing inner edges of the fins.

The steps of constructing the assembly of FIG. 5B may include interleaving the fins, sliding a wicking material down the center of the interleaved fins, and welding the fins to the fill cap. The fins of the assembly may then be positioned within the cathode chamber of an electrochemical cell. Finally, the cathode chamber of the cell may be filled with active material through the aperture of the filling cap and the filling cap may be hermetically sealed. Instead of using two interleaved fins, another design may use four non-interleaved fins (not directly connected to each other) to achieve a similar configuration and performance. However, the interleaved configuration may improve the rigidity of the assembly.

The interleaved metal fin current collector concept allows for a modular approach to be taken with respect to current collectors. For example, in some electrochemical cell configurations, only one of the fins may be used, providing sufficient performance for a particular application (e.g., a low discharge rate application) while reducing the cost. In other applications, both fins may be used in the interleaved manner described herein (e.g., in high discharge rate applications where increased performance is needed and the increased cost can be tolerated). Furthermore, a wicking material may be used in some configurations and not in other configurations. In accordance with other embodiments, more than two fins may be interleaved in a similar manner to form a current collector. However, any performance gains may be offset by corresponding cost increases when a fin is added. As can be seen, the modular nature of an interleaved, multi-fin current collector design allows for multiple possible configurations, allowing tradeoffs to be made between cost and performance.

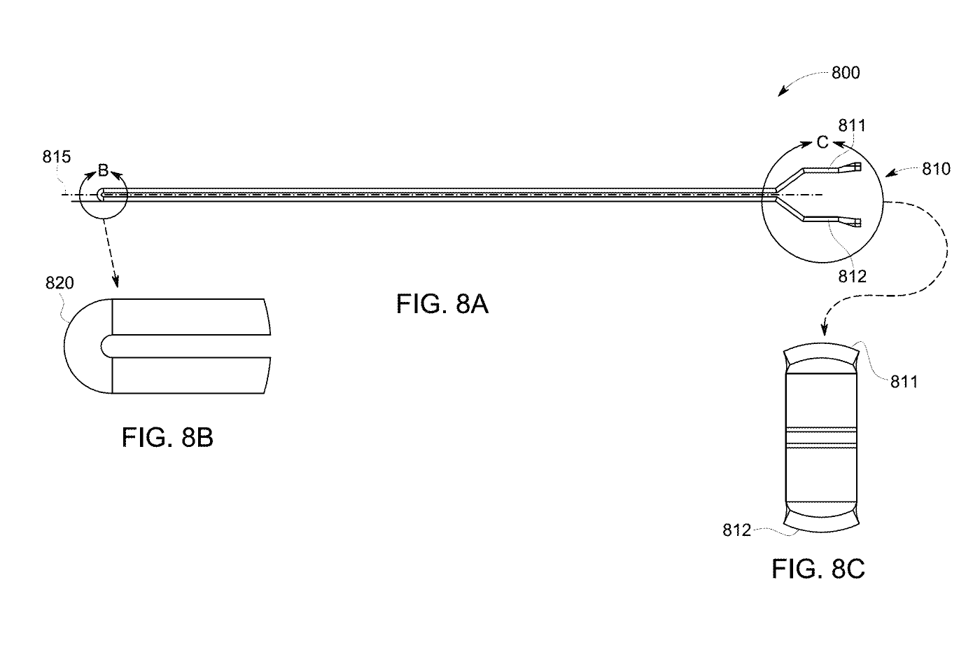

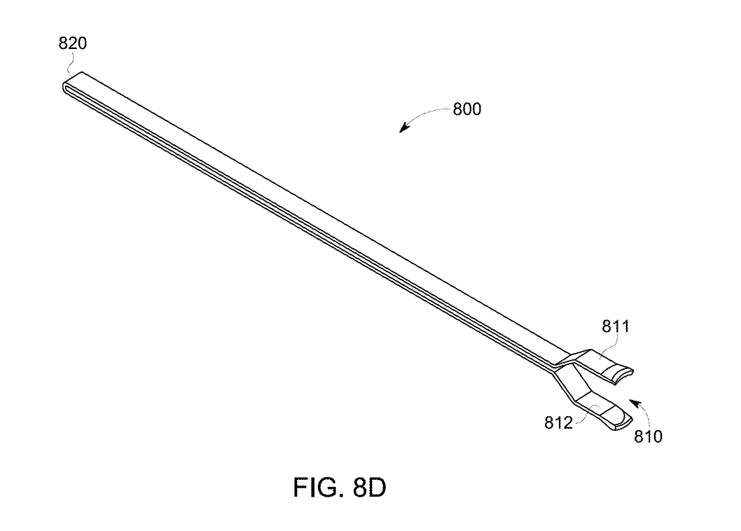

FIG. 8A illustrates a schematic representation of a side view of an example embodiment of a folded current collector 800 that may be used in the electrochemical cell 100 of FIG. 1 in place of the conventional current collector 190 of FIG. 2A and FIG. 2B. The current collector 800 is a substantially flat and elongated single metal fin that is folded in half to form a fork 810 at a proximal end of the current collector 800 and a bend 820 at a distal end of the current collector 800. Due to the folding in half of the single metal fin, the bend 820 at the distal end (i.e., at the fold) is about 180° with respect to a dominant longitudinal axis 815 of the current collector 800.

FIG. 8B illustrates a blown up side view of the bend 820 at the distal end of the folded current collector 800 of FIG. 8A. FIG. 8C illustrates a blown up front view of the fork 810 at the proximal end of the folded current collector 800 of FIG. 8A. FIG. 8D illustrates a perspective view of the folded current collector 800 of FIG. 8A.

The fork 810 includes two bent prongs 811 and 812 configured to be connected to the outer metal ring 120 of the electrochemical cell 100. Each of the two bent prongs 811 and 812 has a rounded outer tip configured to match a curvature of an inner wall of the outer metal ring 120. The two bent prongs 811 and 812 provide a spring tension to hold each of the rounded outer tips against the inner wall to allow for easier welding. The rounded outer tips may then be joined (e.g., via welding or brazing) to the inner wall. In such a configuration, the inner metal ring is not used, since the prongs 811 and 812 are joined to the outer metal ring 120. The aperture of the outer metal ring, bounded by the inner wall of the outer metal ring, may be used to fill the cathode chamber 150 therethrough and may subsequently be hermetically sealed.

In accordance with an embodiment, a wicking material (e.g., carbon felt) may be positioned along the dominant longitudinal axis 815 of the current collector 800 and may be held in place by tension between the two folded halves of the single metal fin. The current collector 800 and the outer metal ring 120 may be made of nickel or nickel-plated copper for example. Other electrically conductive materials may be possible as well, in accordance with various other embodiments.

In accordance with an embodiment, the current collector 800 may be about 225 mm long after bending (about 450 mm long before bending). Relative to the conventional current collector 190, the current collector 800 provides a lower electrical resistance of the current collector itself, and a slightly higher ionic resistance between the current collector and the active cathode material. Other dimensions of the current collector 800 are possible as well, in accordance with other embodiments. In accordance with one embodiment, the length of the folded current collector may range from 110 mm to 450 mm and the width may range from 8 mm to 32 mm. In accordance with another embodiment, the length of the folded current collector may range from 200 mm to 250 mm and the width may range from 12 mm to 20 mm. Again, a total cross-sectional area of the current collector 800, after folding, may be between 10 mm² and 40 mm². However, other cross-sectional areas are possible as well, in accordance with other embodiments.

With reference to the drawings, like reference numerals designate identical or corresponding parts throughout the several views. However, the inclusion of like elements in different views does not mean a given embodiment necessarily includes such elements or that all embodiments of the invention include such elements.

In the specification and claims, reference will be made to a number of terms have the following meanings The singular forms “a”, “an” and “the” include plural referents unless the context clearly dictates otherwise. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value.

In appended claims, the terms “including” and “having” are used as the plain language equivalents of the term “comprising”; the term “in which” is equivalent to “wherein.” Moreover, in appended claims, the terms “first,” “second,” “third,” “upper,” “lower,” “bottom,” “top,” etc. are used merely as labels, and are not intended to impose numerical or positional requirements on their objects. Further, the limitations of the appended claims are not written in means-plus-function format and are not intended to be interpreted based on 35 U.S.C. §112, sixth paragraph, unless and until such claim limitations expressly use the phrase “means for” followed by a statement of function void of further structure. As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. Moreover, certain embodiments may be shown as having like or similar elements, however, this is merely for illustration purposes, and such embodiments need not necessarily have the same elements unless specified in the claims.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A current collector for a sodium-metal halide electrochemical cell, comprising:
at least one substantially flat and elongated metal fin being electrically conductive and having at least one bend with respect to a dominant longitudinal axis of the current collector,
wherein the at least one substantially flat and elongated metal fin is configured to be joined to a metal ring of the electrochemical cell.

2. The current collector of claim 1, wherein:
the metal fin has a proximal end and a distal end, the proximal end being configured to be joined to the metal ring of the electrochemical cell by one of welding or brazing; and
the at least one bend is nearer to the proximal end than to the distal end and is less than or equal to 90° with respect to the dominant longitudinal axis of the current collector.

3. The current collector of claim 2, wherein:
the at least one bend is less than or equal to 45° with respect to the dominant longitudinal axis of the current collector.

4. The current collector of claim 2, wherein the metal ring has an outer circumference and an inner circumference, and wherein the proximal end of the current collector is configured to be joined to a portion of the inner circumference.

5. The current collector of claim 2, wherein the at least one substantially flat and elongated metal fin is tapered along a length dimension, being widest at the proximal end of the current collector.

6. The current collector of claim 1, wherein the metal ring includes one of an outer metal ring of the electrochemical cell or an inner metal ring of the electrochemical cell.

7. The current collector of claim 1, wherein the at least one substantially flat and elongated metal fin is curved in a width dimension providing rigidity.

8. The current collector of claim 1, wherein the current collector is configured to be substantially centered within the electrochemical cell when joined to the metal ring.

9. The current collector of claim 1, wherein the at least one substantially flat and elongated metal fin comprises at least two interleaved metal fins, each fin having a respective distal end and a respective split proximal end.

10. The current collector of claim 9, wherein the split proximal end of each fin provides two connection surfaces to the metal ring in the form of two bends of the at least one bend.

11. The current collector of claim 9, wherein the at least two interleaved metal fins are not in direct contact with each other.

12. The current collector of claim 9, further comprising a wicking material running along a central axis of the at least two interleaved metal fins in a length dimension, wherein each of the at least two interleaved metal fins are slotted along the central axis to accommodate the wicking material.

13. The current collector of claim 1, wherein the at least one substantially flat and elongated metal fin is folded in half to form a fork at a proximal end of the current collector and to form the at least one bend at a distal end of the current collector, wherein the at least one bend is about 180° with respect to the dominant longitudinal axis of the current collector.

14. The current collector of claim 13, wherein the fork includes two bent prongs configured to be connected to the metal ring of the electrochemical cell, wherein the metal ring is an outer ring of the electrochemical cell, and wherein each of the two bent prongs includes a rounded outer tip configured to match a curvature of an inner wall of the outer ring, and wherein the two bent prongs provide a spring tension to hold each of the rounded outer tips against the inner wall.

15. The current collector of claim 13, further comprising a wicking material running along the dominant longitudinal axis of the current collector.

16. An electrochemical cell, comprising:
a cathode chamber containing an active material;
at least one metal ring positioned above the cathode chamber; and
a current collector residing within the cathode chamber, wherein the current collector includes at least one substantially flat and elongated metal fin being electrically conductive and having at least one bend with respect to a dominant longitudinal axis of the current collector, and wherein the at least one substantially flat and elongated metal fin is joined to the at least one metal ring.

17. The electrochemical cell of claim 16, wherein the active material includes a mix of at least nickel, salt, and a liquid electrolyte.

18. The electrochemical cell of claim 16, wherein the current collector and the at least one metal ring are made of nickel or nickel-plated copper.

19. The electrochemical cell of claim 16, wherein the at least one substantially flat and elongated metal fin is joined to the at least one metal ring via one of welding or brazing.

20. A method of assembling an electrochemical cell, the method comprising:
interleaving at least two substantially flat and elongated metal fins, wherein each fin has a split proximal end and a distal end, and wherein each fin is slotted along a central axis in a length dimension to accommodate the interleaving and a wicking material;
positioning the wicking material along the slotted central axes of the at least two interleaved metal fins;
joining the split proximal end of each metal fin to a metal filling cap;
positioning the interleaved metal fins, having the wicking material, into a cathode cavity of an electrochemical cell; and
filling the cathode cavity of the electrochemical cell with an active material through the metal filling cap.

21. The method of claim 20, further comprising sealing the metal filling cap.

22. The method of claim 20, wherein the joining includes one of welding or brazing.
